(19) United States
(12) Patent Application Publication
(10) Pub. No.: US 2025/0374131 A1
(43) Pub. Date: Dec. 4, 2025

(54) INFORMATION TRANSCEIVING METHOD AND APPARATUS

(71) Applicant: FUJITSU LIMITED, Kawasaki-shi (JP)

(72) Inventors: Gang SUN, Beijing (CN); Jian ZHANG, Beijing (CN); Meiyi JIA, Beijing (CN)

(73) Assignee: FUJITSU LIMITED, Kawasaki-shi (JP)

(21) Appl. No.: 19/297,036

(22) Filed: Aug. 12, 2025

Related U.S. Application Data
(63) Continuation of application No. PCT/CN2023/076169, filed on Feb. 15, 2023.

(51) Int. Cl. H04W 36/00; H04W 36/04; H04W 72/21; H04W 76/20

(52) U.S. Cl. CPC H04W 36/0058; H04W 36/04; H04W 72/21; H04W 76/20

(57) ABSTRACT

An information transceiving apparatus, applicable to a terminal equipment, includes: a first receiver configured to receive event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility; and a first transmitter configured to transmit a measurement report to the network device according to the event triggered information.

### CROSS-REFERENCE TO RELATED APPLICATION

This application is a continuation application under 35 U.S.C. 111(a) of International Patent Application PCT/CN2023/076169 filed on Feb. 15, 2023, and designated the U.S., the entire contents of which are incorporated herein by reference.

### TECHNICAL FIELD

This disclosure relates to the field of communication technologies.

### BACKGROUND

Mobility management is an essential mechanism for cellular mobile communication systems, and is able to assist new radio (NR) systems in achieving load balancing and provide users with better experiences and improve overall performances of the systems. When a terminal equipment moves from a coverage area of one cell to a coverage area of another cell, a serving cell of the terminal equipment needs to be switched.

At present, switch of the serving cell of the terminal equipment is triggered by measurement of layer 3 and achieved by reconfiguring the serving cell by radio resource control (RRC) signaling. When the RRC signaling reconfigures the serving cell, operations of layer 1 and layer 2 of the communication system need to be reset, thereby resulting in relatively large system delay, signaling load and relatively long communication interruption time. Therefore, it is proposed to trigger by a measurement result of layer 1 and switch the serving cell by signaling of layer 1/layer 2. Hence, system delay, signaling load and communication interruption time may be effectively reduced.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In current communication standards, in order to support L1/L2 triggered mobility management, a network device is configured with information relevant to neighbor candidate cells, reference signals of the neighbor candidate cells to be measured, and a terminal equipment needs to report measurement results to the network device. For reporting of a measurement result of layer 1 scheduled by the network device, periodic reporting, semi-periodic reporting and aperiodic reporting are supported, and the network device configures reporting configuration information (configured by RRC signaling) for the terminal equipment, the reporting configuration information including a type of reporting mode (periodic, semi-periodic, aperiodic) and the parameters relevant to the reporting mode.

However, taking limitations of uplink resources and referability of measurement results of neighbor candidate cells into account, a terminal equipment may possibly not be able to report or does not necessarily report all measurement results. There is currently no corresponding solution for a terminal equipment to report a measurement result of layer 1 for such a case.

In order to solve at least one of the above problems, embodiments of this disclosure provide an information transceiving method and apparatus.

According to one aspect of the embodiments of this disclosure, there is provided an information transceiving apparatus, applicable to a terminal equipment, characterized in that the apparatus includes:
a first receiving unit configured to receive event triggered information of measurement result reporting of a neighbor candidate cell transmitted by a network device, the event triggered information being used to indicate the terminal equipment to trigger measurement result reporting of a neighbor candidate cell with an event as a condition, measurement of the neighbor candidate cell being used for layer 1/layer 2 triggered mobility; and
a first transmitting unit configured to transmit a measurement report to the network device according to the event triggered information.

According to another aspect of the embodiments of this disclosure, there is provided an information transceiving apparatus, applicable to a network device, characterized in that the apparatus includes:
a second transmitting unit configured to transmit event triggered information of measurement result reporting of a neighbor candidate cell to a terminal equipment, the event triggered information being used to indicate the terminal equipment to trigger the measurement result reporting of the neighbor candidate cell with an event as a condition, measurement of the neighbor candidate cell being used for layer 1/layer 2 triggered; and
a second receiving unit configured to receive a measurement report transmitted by the terminal equipment.

According to a further aspect of the embodiments of this disclosure, there is provided a communication system, including a terminal equipment and/or a network device, the terminal equipment including the information transceiving apparatus described in the one aspect, and the network device including the information transceiving apparatus described in the other aspect.

An advantage of the embodiments of this disclosure exists in that by configuring the terminal equipment with the event triggered information of measurement result reporting of a neighbor candidate cell, the terminal equipment is enabled to trigger measurement result reporting of the neighbor candidate cell with an event as a condition, which may further reduce a load of the measurement result reporting of the neighbor cell, and support layer 1/layer 2 triggered mobility, that is, triggering may be performed according to the measurement result of layer 1, and switch of a serving cell may be performed according to signaling of layer 1/layer 2. Hence, system delay, signaling load and communication interruption time may be effectively reduced.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of an information transceiving method of embodiments of this disclosure;

FIG. 3 is a schematic diagram of an information transceiving method of embodiments of this disclosure;

FIG. 4 is a schematic diagram of a cell switch method of embodiments of this disclosure;

FIG. 5 is a schematic diagram of a cell switch method of embodiments of this disclosure;

FIG. 6 is a schematic diagram of an information transceiving apparatus of embodiments of this disclosure;

FIG. 7 is a schematic diagram of an information transceiving apparatus of embodiments of this disclosure;

FIG. 8 is a schematic diagram of a network device of embodiments of this disclosure; and

FIG. 9 is a schematic diagram of a terminal equipment of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

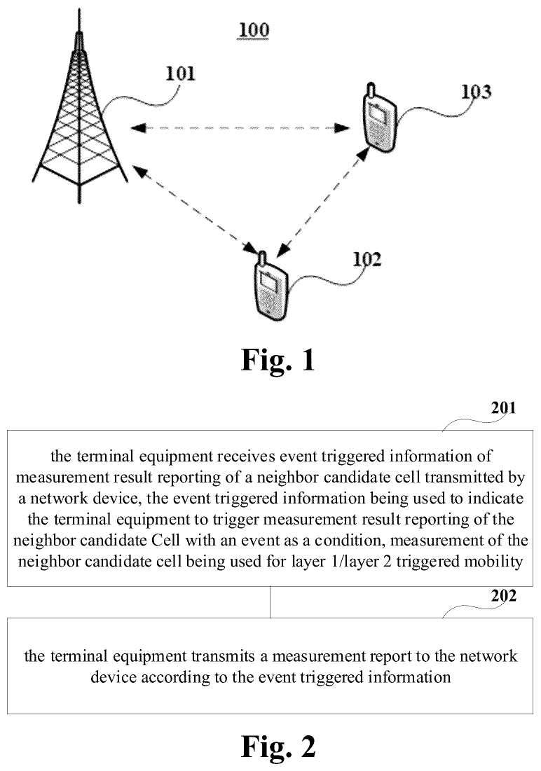

FIG. 1 is a schematic diagram of a communication system of embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but not limited to an enhanced mobile broadband (eMBB), massive machine type communication (mMTC), and ultra-reliable and low-latency communication (URLLC), etc.

The terminal equipment 102 may transmit data to the network device 101, such as in a granted or grant-free transmission manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

A communication protocol stack is divided into three layers, in which layer 1 includes a physical layer, layer 2 includes a radio link control (RLC) layer and a media access control (MAC) layer, and layer 3 includes an RRC layer.

Currently, in reference signal measurement resource configuration for layer 1 measurement, an information field servingAdditionalPCIList-r17 is included and is associated with reference signals in a reference signal set. For example, when the reference signals are synchronization signal blocks, synchronization signal block measurement resource configuration for layer 1 measurement may be expressed as follows by using an ASN.1 syntax:

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI- |

```
SSB-ResourcePerSet)) OF SSB-Index,
  ...,
  [[
```

| | |
|---|---|
| servingAdditionalPCIList-r17 | SEQUENCE (SIZE(1..maxNrofCSI- |

SSB-ResourcePerSet)) OF ServingAdditionalPCIIndex-r17
OPTIONAL -- Need R
]]
}

| | |
|---|---|
| ServingAdditionalPCIIndex-r17 ::= | INTEGER(0..maxNrofAdditionalPCI- |

r17)
-- TAG-CSI-SSB-RESOURCESET-STOP
-- ASN1STOP

For the information field servingAdditionalPCIList-r17, its content is a physical cell ID index of a neighbor candidate cell. When its value is 0, it indicates that the reference signals are reference signals of a current serving cell, and when it is not 0, the value is AdditionalPCIIndex-r17, indicating that the reference signals are reference signals of the neighbor candidate cell.

In addition, the physical cell ID index value AdditionalPCIIndex-r17 of the neighbor candidate cell is configured in an SSB measurement timing configuration (SSB-MTC) information element, which may be expressed as follows by using an ASN.1 syntax:

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, |

ms40, ms80, ms160, spare2, spare1 },

| | |
|---|---|
| ssb-PositionsInBurst-r17 | CHOICE { |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}

| | |
|---|---|
| AdditionalPCIIndex-r17 ::= | INTEGER(1..maxNrofAdditionalPCI-r17) |

That is, an information field SSB-MTC-AdditionalPCI-r17 is included the measurement timing configuration information element SSB-MTC for the neighbor candidate cell SSBs, including the physical cell ID index (AdditionalPCIIndex-r17), a physical cell ID and parameters related to measurement, such as a period of the SSB, time-domain position of the SSB, and power, etc.

As described above, for the reporting of the measurement result of layer 1 scheduled by the network device, periodic reporting, semi-periodic reporting and aperiodic reporting are supported, and the network device configures the reporting configuration information for the terminal equipment (configured via RRC signaling), the reporting configuration information including a type of reporting mode (periodic, semi-periodic, aperiodic) and the parameters relevant to the reporting modes. The reporting configuration information may be expressed by the information element CSI-ReportConfig, CSI-ReportConfig being expressed as follows by using an ASN.1 syntax:

| -- ASN1START | |
|---|---|
| CSI-ReportConfig ::= | SEQUENCE { |
| reportConfigId | CSI-ReportConfigId, |
| carrier | ServCellIndex |
| OPTIONAL, -- Need S | |
| resourcesForChannelMeasurement | CSI-ResourceConfigId, |
| csi-IM-ResourcesForInterference | CSI-ResourceConfigId |
| OPTIONAL, -- Need R | |
| nzp-CSI-RS-ResourcesForInterference | CSI-ResourceConfigId |
| OPTIONAL, -- Need R | |
| reportConfigType | CHOICE { |
| periodic | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| }, | |
| semiPersistentOnPUCCH | SEQUENCE { |
| reportSlotConfig | CSI- |
| ReportPeriodicityAndOffset, | |
| pucch-CSI-ResourceList | SEQUENCE (SIZE |
| (1..maxNrofBWPs)) OF PUCCH-CSI-Resource | |
| }, | |
| semiPersistentOnPUSCH | SEQUENCE { |
| reportSlotConfig | ENUMERATED {sl5, |
| sl10, sl20, sl40, sl80, sl160, sl320}, | |
| reportSlotOffsetList | SEQUENCE (SIZE (1.. |
| maxNrofUL-Allocations)) OF INTEGER(0..32), | |
| p0alpha | P0-PUSCH- |
| AlphaSetId | |
| }, | |
| aperiodic | SEQUENCE { |
| reportSlotOffsetList | SEQUENCE (SIZE |

```
(1..maxNrofUL-Allocations)) OF INTEGER(0..32)
      },
  ......
    }
-- ASN1STOP
```

In the information element CSI-ReportConfig, an information field reportConfigType supports configuration options for the periodic reporting, the semi-periodic reporting and the aperiodic reporting (one of them is selected), and the parameters (such as a reporting slot reportSlotConfig, etc.) relevant to the reporting modes are configured.

Currently, configured measurement reporting resources for measurement reporting scheduled by the network device are limited, and only support reporting up to 4 measurement results. On the other hand, not all measurement results of every neighbor candidate cell need to be reported. For example, if signal quality of a neighbor candidate cell is relatively poor, the neighbor candidate cell is unlikely to be selected as a target cell in cell switch. At this point, there is no need to report the measurement result of the neighbor candidate cell.

That is, taking limitations of uplink resources and referability of measurement results of neighbor candidate cells into account, a terminal equipment may possibly not be able to report or does not necessarily report all measurement results. There is currently no corresponding solution for a terminal equipment to report the measurement result of layer 1 for such a case.

Regarding the above problems, the embodiments of this disclosure provide an information transceiving method and apparatus, which shall be described below with reference to the accompanying drawings and embodiments.

### Embodiments of a First Aspect

The embodiments of this disclosure provide an information transceiving method, which shall be described from a terminal equipment side.

FIG. 2 is a schematic diagram of the information transceiving method of the embodiments of this disclosure. As shown in FIG. 2, the method includes:
201: the terminal equipment receives event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility; and
202: the terminal equipment transmits a measurement report to the network device according to the event triggered information.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

With the above embodiments, by configuring the terminal equipment with the event triggered information of measurement result reporting of a neighbor candidate cell, the terminal equipment is enabled to trigger measurement result reporting of the neighbor candidate cell with an event as a condition, which may further reduce a load of measurement result reporting of the neighbor candidate cell, and support layer 1/layer 2 triggered mobility, that is, triggering may be performed according to the measurement result of layer 1, and switch of a serving cell may be performed according to signaling of layer 1/layer 2. Hence, system delay, signaling load and communication interruption time may be effectively reduced.

In some embodiments, measurement of the neighbor candidate cell is used for layer 1/layer 2 triggered mobility, or, layer 1 measurements of the neighbor candidate cell is used to support layer 1/layer 2 switch of the neighbor candidate cell, that is, switch of a serving cell is performed via layer 1/layer 2 signaling, or, switch of a serving cell is not triggered by layer 3 measurement.

It should be noted that in following embodiments, names, data types and value ranges of information fields are illustrative only, and are not limited in the embodiments of this disclosure, which shall be illustrated below.

In some embodiments, the network device of the serving cell may configure reference signal resources for measurement of a current serving cell and a neighbor cell, that is, the method may include: the network device transmits reference signal measurement resource configuration information for layer 1 measurement to the terminal equipment, the reference signal measurement resource configuration information being carried by RRC signaling. The configured measurement resources are a resource set list (reference signal set), each resource set consisting of one or more measurement resources (reference signals). In other words, the network device may configure the terminal equipment with multiple reference signals for layer 1 measurement of the neighbor candidate cell. The reference signal measurement resource configuration information includes a reference signal set identifier (measurement resource set identifier), an index/indices of one or more measurement resources (reference signals) constituting the reference signal set (measurement resource set) and indices of cell identifiers associated with the reference signals. In other words, when the reference signal measurement resource configuration information includes the indices of the cell identifiers with which the reference signals are associated, it indicates that the configured reference signal set is used for measurement of layer 1/layer 2 triggered mobility. The indices of the cell identifiers correspond to the reference signals one by one, wherein that the reference signals are associated with the cell refers to that the reference signals are transmitted by a network device of the associated cell. By adding this association, it may indicate a cell from which each reference signal in the reference signal set comes, and the terminal equipment achieves measurement of the associated cell by measuring quality of the reference signal of the cell. The associated cell includes the current serving cell and/or the neighbor candidate cell, the neighbor candidate cell including an intra-frequency neighbor candidate cell and/or an inter-frequency neighbor candidate cell. The reference signal includes an SSB or a CSI-RS, the CSI-RS being a CSI-RS for beam management, or a CSI-RS for interference management (CSI-IM), or a CSI-RS for time-frequency tracking (TRS); however, the embodiments of this disclosure are not limited thereto.

For example, when the reference signal is an SSB, the reference signal measurement resource configuration information used for layer 1 measurement may be expressed by an existing information element CSI-SSB-ResourceSet, when the reference signal is a CSI-RS used for beam measurement, the reference signal measurement resource configuration information used for layer 1 measurement may be expressed by an existing information element NZP-CSI-RS-ResourceSet, and when the reference signal is a CSI-RS for interference management (CSI-IM), the reference signal measurement resource configuration information used for layer 1 measurement may be expressed by an existing information element CSI-IM-ResourceSet, etc. Reference may be made to the related art for compositions of the above information elements, which shall not be repeated herein any further.

In some embodiments, the network device of the serving cell may further transmit reporting configuration information of the layer 1 measurement, the reporting configuration information being used to configure parameters needed in layer 1 measurement reporting of the terminal equipment. For example, the reporting configuration information includes a report quantity, a report configuration ID, a report mode type, and the parameters relevant to the report mode, etc. For example, the report quantity includes L1-RSRP (reference signal receive power) or L1-SNR (signal to Noise ratio). For example, the report mode type includes periodic, semi-periodic, or aperiodic, and the reporting configuration information of the layer 1 measurement may be expressed by an existing information element CSI-ReportConfig, and details thereof are as described above, which shall not be repeated herein any further.

In some embodiments, in order to reduce a load of uplink reporting, an event-triggered report mode may be used for a report mode of layer 1 measurement result of the neighbor candidate cell. Therefore, the network device may further configure event triggered information of the layer 1 measurement result reporting of the neighbor candidate cell. The event triggered information is used to indicate the terminal equipment to trigger measurement result reporting of the neighbor candidate cell with an event as a condition. That is, when a measurement result of a neighbor candidate cell satisfies an entering condition of an event, the terminal equipment starts reporting the measurement result of the neighbor candidate cell to the network device, until a leaving condition is satisfied; and when a measurement result of a neighbor candidate cell satisfies a leaving condition of the event, the terminal equipment starts not to report a measurement result of a corresponding neighboring candidate cell to the network device, until the entering condition is satisfied. In the following description, the entering condition may also be referred to as a triggering condition or a starting condition, and the leaving condition may also be referred to as a cancellation condition or an ending condition, etc., and the embodiments of this disclosure are not limited thereto.

In some embodiments, the event triggered information is optional, that is, the network device may or may not transmit the event triggered information. When the event triggered information is transmitted, it indicates that the terminal equipment triggers measurement result reporting of the neighbor candidate cell with an event as a condition, and when the event triggered information is not transmitted, it indicates that the terminal equipment does not trigger measurement result reporting of the neighbor candidate cell with an event as a condition.

In some embodiments, the event triggered information includes an event identifier, that is, when the network device transmits the event triggered information and the event triggered information includes an event identifier A, it indicates that the terminal equipment triggers measurement result reporting of the neighbor candidate cell with an event A as a condition, and when the network device transmits the event triggered information and the event triggered information includes an event identifier B, it indicates that the terminal equipment triggers measurement result reporting of the neighbor candidate cell with an event B as a condition, which shall not be enumerated herein any further. The above events and how to configure them shall be described later.

In some embodiments. The event triggered information may further include time-frequency resource information of measurement result reporting of the neighbor candidate cell. The time-frequency resource information may be periodic, or aperiodic, or semi-periodic, and the embodiments of this disclosure are not limited thereto. That is, when the network device transmits the event triggered information and the event triggered information includes event identifier A+time-frequency resource R, it indicates that the terminal equipment triggers measurement result reporting of the neighbor candidate cell with the event A as a condition, and transmits the measurement result of the neighbor candidate cell on time-frequency resource R, and when the network device transmits the event triggered information and the event triggered information includes event identifier B+time-frequency resource R, it indicates that the terminal equipment triggers measurement result reporting of the neighbor candidate cell with the event B as a condition, and transmits the measurement result of the neighbor candidate cell on time-frequency resource R, which shall not be enumerated herein any further. Wherein, when the event triggered information is transmitted but the event triggered information does not include the time-frequency resource information of the measurement result reporting of the neighbor candidate cell, the terminal equipment may transmit the measurement result of the neighbor candidate cell on time-frequency resources of periodic reporting or semi-periodic reporting or aperiodic reporting configured in existing reportConfigType, or transmit the measurement result of the neighbor candidate cell via an uplink resource additionally allocated by the network device; however, the embodiments of this disclosure are not limited thereto, which shall not be enumerated herein any further.

In some embodiments, the event triggered information is carried in configuration information of an MAC layer. The configuration information of the MAC layer may be expressed by using an information element MAC-CellGroupConfig, MAC-CellGroupConfig being expressed as follows by using an ASN.1 syntax:

| | |
|---|---|
| MAC-CellGroupConfig ::= | SEQUENCE { |
| drx-Config | SetupRelease { DRX-Config } |

OPTIONAL, -- Need M

| | |
|---|---|
| schedulingRequestConfig | SchedulingRequestConfig |

OPTIONAL, -- Need

| | |
|---|---|
| bsr-Config | BSR-Config |

OPTIONAL, -- Need M

| | |
|---|---|
| tag-Config | TAG-Config |

OPTIONAL, -- Need M

| | |
|---|---|
| phr-Config | SetupRelease { PHR-Config } |

OPTIONAL, -- Need M

| | |
|---|---|
| skipUplinkTxDynamic | BOOLEAN, |
| NcellEventTriggerReport | L1-report-Event |

```
OPTIONAL
  ...,
  }
```

That is, an information field of the event triggered information NcellEventTriggerReport of the measurement result reporting of the neighbor candidate cell is added into an information element of existing configuration information MAC-CellGroupConfig of the MAC layer, with a data type of L1-report-Event, which is an event identifier ID of the measurement result reporting of the neighbor candidate cell. The information field is optional, and if the information field NcellEventTriggerReport is absent in MAC-CellGroupConfig, it indicates that the terminal equipment does not trigger measurement result reporting of the neighbor candidate cell with an event as a condition, and if the information field is present, it indicates that the terminal equipment triggers measurement result reporting of the neighbor candidate cell with an event as a condition. Names, and data types, etc., of the information fields newly added in the above examples are illustrative only, and the information fields may also be added into other information elements, such as ReportConfigNR, and the embodiments of this disclosure are not limited thereto, which shall not be enumerated herein any further.

In some embodiments, the event triggered information is carried in layer 1 reporting configuration information, the layer 1 reporting configuration information being able to be expressed by the existing information element CSI-ReportConfig, which may be expressed as follows by using an ASN. 1 syntax:

| | |
|---|---|
| CSI-ReportConfig ::= | SEQUENCE reportConfigId |

CSI-ReportConfigI carrier

| | |
|---|---|
| ServCellIndex | OPTIONAL, -- Need |
| resourcesForChannelMeasurement | CSI-ResourceConfigI csi-IM- |
| ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| NcellEventTriggerReport | L1-report-Event |

OPTIONAL

| | |
|---|---|
| reportConfigType | CHOICE { |

```
  ...
  }
  ...
  }
```

That is, the event triggered information NcellEventTriggerReport of the measurement result reporting neighbor candidate cell is added into the information element CSI-ReportConfig of the layer 1 reporting configuration information, with a data type of L1-report-Event, which is an event identifier ID of the measurement result reporting of the neighbor candidate cell. The information field is optional, and if the information field NcellEventTriggerReport is absent in CSI-ReportConfig, it indicates that the terminal equipment does not trigger measurement result reporting of the neighbor candidate cell with an event as a condition, and if the information field is present, it indicates that the terminal equipment triggers measurement result reporting of the neighbor candidate cell with an event as a condition.

As described above, such parameters as the periodic reporting or the semi-periodic reporting or the aperiodic reporting, etc., are also configured in reportConfigType in the information element CSI-ReportConfig of the layer 1 reporting configuration information, and if in addition to such parameters as the periodic reporting or the semi-periodic reporting or the aperiodic reporting, the event triggered information NcellEventTriggerReport of measurement result reporting of the neighbor candidate cell is also present in the layer 1 reporting configuration information, it indicates that the measurement report transmitted by the terminal equipment to the network device includes both measurement result reporting of the neighbor candidate cell satisfying the event triggering (entering) condition and measurement result of a current serving cell. And, the terminal equipment carries the above measurement result on an uplink PUCCH or PUSCHs according to the time-frequency resources of the periodic reporting or the semi-periodic reporting or the aperiodic reporting configured according to reportConfigType.

In some embodiments, the event triggered information may also be taken as a reporting mode type and carried in the reporting mode type information field reportConfigType in the layer 1 reporting configuration information. For example, CSI-ReportConfig may be expressed as follows by using an ASN.1 syntax:

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |

```
              ...
          },
```

| | |
|---|---|
| semiPersistentOnPUCCH | SEQUENCE { |

```
              ...
          },
```

| | |
|---|---|
| semiPersistentOnPUSCH | SEQUENCE { |

```
            ...
          },
```

| | |
|---|---|
| aperiodic | SEQUENCE { |

```
            ...
        },
```

| | |
|---|---|
| eventtrigger | SEQUENCE { |
| NcellEventTriggerReport | L1-report-Event |

OPTIONAL

| | |
|---|---|
| reportSlotOffsetList | SEQUENCE (SIZE |

```
(1..maxNrofUL-Allocations)) OF INTEGER(0..32)
          },
  ...
  }
  ...
  }
```

That is, an event triggered information field eventtrigger of the measurement result reporting of the neighbor candidate cell is add into the existing reportConfigType, the information field including NcellEventTriggerReport, with a data type of L1-report-Event, which is an event identifier ID of a measurement result reporting of the neighbor candidate cell. At the same time, in the information field eventtrigger, information on time-frequency resources of measurement result reporting of the neighbor candidate cell is included, the time-frequency resources being periodic, or semi-periodic, or aperiodic, such as reportSlotOffsetList. With the above configuration, the measurement result of the neighbor candidate cell satisfying the event triggering (entering) condition may be reported separately by using the configured time-frequency resources, and the measurement report may not include the measurement result of the current serving cell.

In some embodiments, the configuration information of the MAC layer or the layer 1 reporting configuration information is carried by RRC signaling.

In some embodiments, the event triggered information may also be carried by the MAC layer, such as carrying the event triggered information by a new MAC CE.

The events and how to configure them shall be described below.

In some embodiments, the events of the layer 1 measurement result reporting of the neighbor candidate cell may reuse events A1-A6 or B1 or B2 defined in an existing layer 3, and reference may be made to the related art for details, which shall not be repeated herein any further.

In some embodiments, the events of the layer 1 measurement result reporting of the neighbor candidate cell may define new events.

For example, the entering (triggering) condition of an event includes that:
a measurement result of the neighbor candidate cell is greater than a measurement result of a current serving cell; or,
a measurement result of the neighbor candidate cell minus a hysteresis parameter is greater than a measurement result of a current serving cell; or,
a measurement result of the neighbor candidate cell is greater than a measurement result of a current serving cell plus an offset; or,
a measurement result of the neighbor candidate cell minus a hysteresis parameter is greater than a measurement result of a current serving cell plus an offset; or,
a measurement result of the neighbor candidate cell is greater than a threshold; or,
a measurement result of the neighbor candidate cell minus a hysteresis parameter is greater than a threshold.

For example, the leaving (cancellation) condition of an event includes that:
a measurement result of the neighbor candidate cell is less than a measurement result of a current serving cell; or,
a measurement result of the neighbor candidate cell plus a hysteresis parameter is less than a measurement result of a current serving cell; or,
a measurement result of the neighbor candidate cell is less than a measurement result of a current serving cell plus an offset; or,
a measurement result of the neighbor candidate cell plus a hysteresis parameter is less than a measurement result of a current serving cell plus an offset; or,
the measurement result of the neighbor candidate cell is less than a threshold; or,
a measurement result of the neighbor candidate cell plus a hysteresis parameter is less than a threshold.

The events shall be illustrated below.

Regarding event A: when the measurement result of the neighbor candidate cell is greater than the measurement result of the current serving cell, the measurement result of the neighbor candidate cell satisfies the event entering condition of the reporting, and the terminal equipment starts to report the measurement result of the neighbor candidate cell to the network device, until the measurement result satisfies the leaving condition.

When the measurement result of the neighbor candidate cell is less than the measurement result of the current serving cell, the measurement result of the neighbor candidate cell satisfies the event leaving condition of the reporting, and the terminal equipment starts not to report the measurement result of the neighbor candidate cell to the network device, until the measurement result satisfies the event entering condition.

$$Entering condition : Mn > Ms ,$$

$$leaving condition : Mn < Ms ;$$

or, based on the above event entering condition or the event leaving condition, a hysteresis parameter is taken into account:

$$entering condition : Mn - Hys > Ms ,$$

$$leaving condition : Mn + Hys < Ms .$$

Regarding event B: when the measurement result of the neighbor candidate cell is greater than the measurement result of the current serving cell plus an offset, the measurement result of the neighbor candidate cell satisfies the event entering condition of the reporting, and the terminal equipment starts to report the measurement result of the neighbor candidate cell to the network device, until the measurement result satisfies the leaving condition.

When the measurement result of the neighbor candidate cell is less than the measurement result of the current serving cell plus an offset, the measurement result of the neighbor candidate cell satisfies the event leaving condition of the reporting, and the terminal equipment starts not to report the measurement result of the neighbor candidate cell to the network device, until the measurement result satisfies the event entering condition.

$$Entering condition : Mn > Ms + offset ,$$

$$leaving condition : Mn < Ms + offset ;$$

or, based on the above event entering condition or the event leaving condition, a hysteresis parameter is taken into account:

$$entering condition : Mn - Hys > Ms + offset ,$$

$$leaving condition : Mn + Hys < Ms + offset .$$

Regarding event C: when the measurement result of the neighbor candidate cell is greater than a preset threshold, the measurement result of the neighbor candidate cell satisfies the event entering condition of the reporting, and the terminal equipment starts to report the measurement result of the neighbor candidate cell to the network device, until the measurement result satisfies the leaving condition.

When the measurement result of the neighbor candidate cell is less than a preset threshold, the measurement result of the neighbor candidate cell satisfies the event leaving condition of the reporting, and the terminal equipment starts not to report the measurement result of the neighbor candidate cell to the network device, until the measurement result satisfies the event entering condition.

$$Entering condition : Mn > threshold ,$$

$$leaving condition : Mn < threshold ;$$

or, based on the above event entering condition or the leaving condition, a hysteresis parameter is taken into account:

$$entering condition : Mn - Hys > threshold ,$$

$$leaving condition : Mn + Hys < threshold .$$

In the above equations, Mn is the measurement result of the neighbor candidate cell, and Ms is the measurement result of the current serving cell. The measurement result of the neighbor candidate cell and the serving cell may be a measurement value of a reference signal in the same measurement period, or may be an average over time domain of a reference signal in multiple identical measurement periods, or may be an average of multiple reference signals belonging to the same cell in the same measurement period, or may be an average of multiple reference signals belonging to the same cell in multiple identical measurement periods. The averaging method avoids unnecessary ping-pong switch; however, the embodiments of this disclosure are not limited thereto. Hys is the hysteresis parameter, which may be set to be 0. Wherein, the measurement result includes L1-RSRP or an L1-SNR, that is, Mn, Ms and threshold are in units of dBm (L1-RSRP) or dB (L1-SNR), an Hys and offset are in units of dB. The above are examples only, and the embodiments of this disclosure are not limited thereto.

The above events are illustrative only, and other events and conditions thereof may also be defined, which shall not be enumerated herein any further.

In some embodiments, the parameters related to (the entering or leaving conditions of) the above events may be configured by the network device side, and the method may further include: the terminal equipment receives event parameter information transmitted by the network device, the event parameter information including an event identifier, and at least one of a threshold, an offset and a hysteresis parameter corresponding to the event identifier, the events being defined by the event parameter information. For example, when multiple types of events are defined, the event parameter information includes event identifiers of each event and at least one of the threshold, offset and hysteresis parameter corresponding to each event identifier, and the event identifier included in the event triggering information is one of the event identifiers of the events defined by the event parameter information. According to the event identifiers in the event triggering information and with reference to the event parameter information, at least one of the threshold, offset and hysteresis parameter corresponding to the event identifier may be determined, that is, the event entering and leaving conditions of the measurement result reporting of the neighbor candidate cell may be determined.

For example, event parameter information may be represented by a newly-added information element L1-EventTriggerConfig. For example, L1-EventTriggerConfig may be expressed as follows by using an ASN.1 syntax:

| L1-EventTriggerConfig::= | SEQUENCE { |
|---|---|
| eventId | CHOICE { |
| eventA | SEQUENCE { |
| hysteresis | Hysteresis, |
| ... | |
| }, | |
| eventB | SEQUENCE { |
| b-offfset | |
| MeasTriggerQuantityOffset | |
| hysteresis | Hysteresis, |
| ... | |
| }, | |
| eventC | SEQUENCE { |
| C-Threshold | |
| MeasTriggerQuantity, | |
| hysteresis | Hysteresis, |

```
    ...
    },
...
}
```

For example, the newly-added information element L1-EventTriggerConfig includes an event identifier A, a hysteresis corresponding to event identifier A, an event identifier B, an offset and a hysteresis parameter corresponding to event identifier B, an event identifier C, and a threshold and a hysteresis parameter corresponding to event identifier C. Reference may be made to existing standards for data types of the parameters described in this embodiments, which shall not be enumerated herein any further.

The above newly-defined information element L1-EventTriggerConfig may be added to the reporting configuration ReportConfigNR as an independent information element, and may be taken as an event of the measurement result reporting of the neighbor candidate cell of layer 1/layer 2 triggered mobility. The parameters of the events defined in the newly-defined information element L1-EventTriggerConfig may also be taken as information fields and added to other event triggered information elements, such as EventTriggerConfig, and CondTriggerConfig-r16, etc., which shall not be illustrated one by one herein any further. The event parameter information may be carried by RRC signaling; however, the embodiments of this disclosure are not limited thereto.

In some embodiments, after the reference signal measurement resource configuration information and event triggered information are configured, the network device of the serving cell and/or the network device of the neighbor candidate cell may transmit their respective reference signals to be measured to the terminal equipment, and the network device transmits corresponding reference signals on corresponding time-frequency resources according to such information configured in the reference signal measurement resource configuration information as time-frequency resources, and periods, etc., so that the terminal equipment performs layer 1 measurement on received reference signals.

In some embodiments, the method may further include:

the terminal equipment measures reference signal quality of the neighbor candidate cell to obtain a measurement result of the neighbor candidate cell. The terminal equipment may determine which neighbor candidate cells need to be measured according to neighbor candidate cell information configured by the network device, obtains the measurement result of the neighbor candidate cell according to a measurement value of a reference signal associated with the neighbor candidate cell, and generates a measurement report according to the event triggered information, that is, performing event evaluation, i.e. performing evaluation according to a configured event. When the measurement result of the neighbor candidate cell satisfies the event entering condition, the terminal equipment starts to include a measurement result of a corresponding neighbor candidate cell in the measurement report, until the measurement result of the neighbor candidate cell satisfies the leaving condition; and when the measurement result of the neighbor candidate cell satisfies the event leaving condition, the terminal equipment starts to exclude a measurement result of a corresponding neighbor candidate cell in the measurement report, until the measurement result of the neighbor candidate cell satisfies the entering condition. The entering condition and the leaving condition of each event are as described above, which shall not be repeated herein any further. Optionally, the terminal equipment is further used to measure reference signal quality of a serving cell to obtain a measurement result of the serving cell.

In some embodiments, in 202, the measurement report is carried by an MAC PDU and/or UCI, and is transmitted on a corresponding PUSCH and/or PUCCH.

For example, the measurement report includes the measurement result of the neighbor candidate cell satisfying the event entering condition, which may be carried by an MAC CE, that is, the measurement result of the neighbor candidate cell satisfying the event entering condition is carried by the MAC PDU. Optionally, resource evaluation is also needed, that is, evaluating whether there are sufficient uplink resources (PUSCHs) to carry measurement results needing to be reported. If there are sufficient uplink resources, the terminal equipment generates an MAC PDU of the measurement result reporting of the neighbor candidate cell satisfying the event entering condition, and transmits the measurement result of the neighbor candidate cell on a corresponding uplink resource (PUSCH). If uplink resources are insufficient to support the measurement result reporting of the neighbor candidate cell satisfying the event entering condition, that is, there are no sufficient uplink resources to carry measurement results needing to be reported, the terminal equipment needs further to transmit to the network device a scheduling request (SR) signal requesting allocation of uplink resources. The network device makes response via uplink grant signaling (such as being carried by DCI) to the SR of the terminal equipment by allocating uplink resources to the terminal equipment. After receiving the UL grant signaling, the terminal equipment generates an MAC PDU of the measurement result reporting of the neighbor candidate cell satisfying the event entering condition, and carries it on an uplink resource allocated by the network device via an uplink grant. If all measurement results of the neighbor candidate cell satisfy the event leaving condition (or there exists no measurement result of the neighbor candidate cell satisfying the event entering condition), the terminal equipment does not need to generate an MAC PDU of the measurement result reporting of the neighbor candidate cell, nor does it need to report the measurement result of the neighbor candidate cell, nor does it need to evaluate uplink resources for it.

For example, the measurement report may be carried by UCI. If measurement result(s) of one or more neighbor candidate cells satisfy the event entering condition, the terminal equipment will include a measurement result of a corresponding neighbor candidate cell (and, optionally, the measurement result of the serving cell) in a measurement report of the UCI, and transmit a measurement result of a neighbor cell on an uplink resource configured by the network device. If all measurement results of the neighbor candidate cell satisfy the event leaving condition (or there exists no measurement result of the neighbor candidate cell satisfying the event entering condition), the measurement report in the UCI does not include the measurement result of the neighbor candidate cell, and, optionally, it may include the measurement result of the serving cell.

For example, the measurement report may be jointly carried by the MAC PDU and the UCI. For example, the measurement report includes the measurement result of the neighbor candidate cell satisfying the event entering condition and the measurement result of the serving cell, wherein the measurement result of the neighbor candidate cell is carried by the MAC PDU, and the measurement result of the serving cell is carried by the UCI, or, measurement results of parts of neighbor candidate cells are carried by the MAC PDU, and measurement results of other parts of neighbor candidate cells and the measurement result of the serving cell are carried by the UCI. For example, if there exist extra UCI resources after the measurement result of the serving cell is carried, measurement results of parts of neighbor candidate cells may be carried on the UCI; however, the embodiments of this disclosure are not limited thereto.

In some embodiments, when the event triggered information is carried by the configuration information of the MAC layer, the measurement result of the neighbor candidate cell is carried and reported by the MAC PDU, and when the event triggered information is carried by the layer 1 reporting configuration information, the measurement result of the neighbor candidate cell is carried and reported by the UCI; however, this is illustrative only, and the embodiments of this disclosure are not limited thereto. For example, when the event triggered information is reported by the layer 1 reporting configuration information, the measurement result of the neighbor candidate cell may be carried and reported by the MAC PDU, which shall not be enumerated herein any further.

In some embodiments, the network device of the serving cell may select a target cell for switch according to an algorithm after receiving the measurement report, and transmit a switch command to the terminal equipment via signaling of layer 1 or layer 2.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, by configuring the terminal equipment with the event triggered information of measurement result reporting of a neighbor candidate cell, the terminal equipment is enabled to trigger measurement result reporting of the neighbor candidate cell with an event as a condition, which may further reduce a load of measurement result reporting of the neighbor candidate cell, and support layer 1/layer 2 triggered mobility, that is, triggering may be performed according to the measurement result of layer 1, and switch of a serving cell may be performed according to signaling of layer 1/layer 2. Hence, system delay, signaling load and communication interruption time may be effectively reduced.

### Embodiments of a Second Aspect

The embodiments of this disclosure provide an information transceiving method, which shall be described from a network device side, with contents identical to those in the embodiments of the first aspect being not going to be described herein any further.

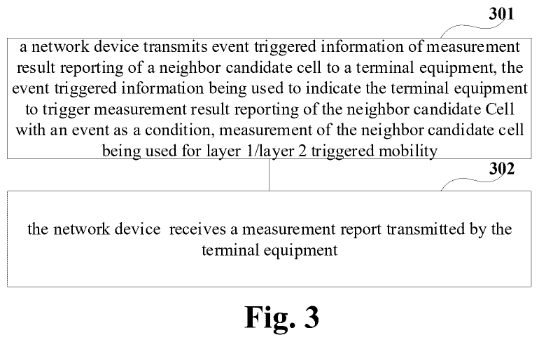

FIG. 3 is a schematic diagram of the information transceiving method of the embodiments of this disclosure. As shown in FIG. 3, the method includes:
301: a network device transmits event triggered information of measurement result reporting of a neighbor candidate cell to a terminal equipment, the event triggered information being used to indicate the terminal equipment to trigger measurement result reporting of the neighbor candidate cell with an event as a condition, measurement of the neighbor candidate cell being used for layer 1/layer 2 triggered mobility; and
301: the network device receives a measurement report transmitted by the terminal equipment.

It should be noted that FIG. 3 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 3.

In some embodiments, implementations of 301-302 corresponds to those of 201-202, and reference may be made to the embodiments of the first aspect for implementations the information, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

With the above embodiments, by configuring the terminal equipment with the event triggered information of measurement result reporting of a neighbor candidate cell, the terminal equipment is enabled to trigger measurement result reporting of the neighbor candidate cell with an event as a condition, which may further reduce a load of the measurement result reporting of the neighbor candidate cell, and support layer 1/layer 2 triggered mobility, that is, triggering may be performed according to the measurement result of layer 1, and switch of a serving cell may be performed according to signaling of layer 1/layer 2. Hence, system delay, signaling load and communication interruption time may be effectively reduced.

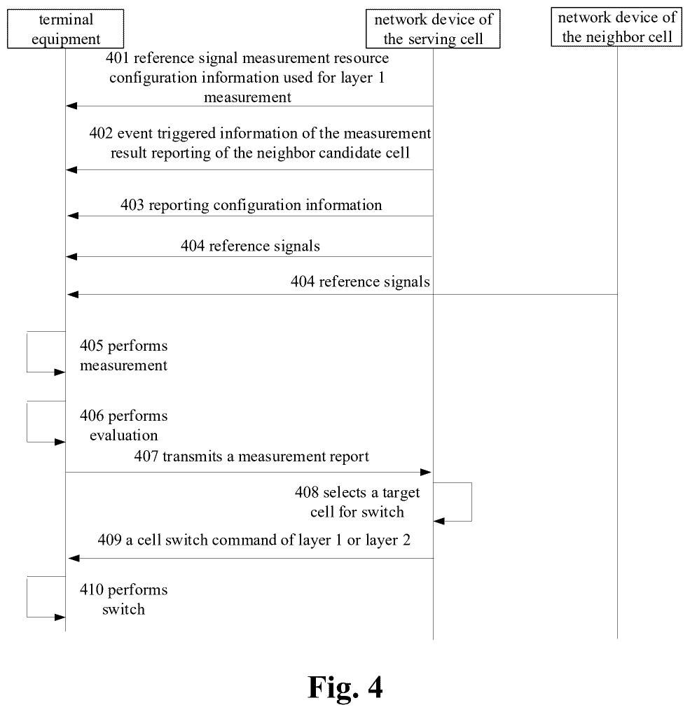

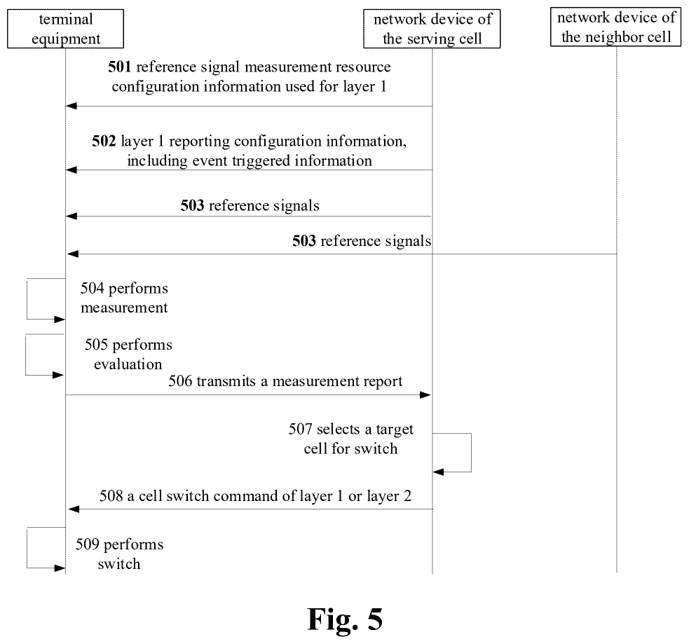

The cell switch methods of the embodiments of this disclosure are described above for the embodiments of the first and second aspects. FIG. 4 and FIG. 5 are schematic diagrams of methods of cell switch triggered by layer 1/layer 2 of the embodiments of this disclosure. As shown in FIG. 4, the method includes:
401: a network device of a serving cell transmits reference signal measurement resource configuration information used for layer 1 measurement to the terminal equipment;
402: the network device of the serving cell transmits event triggered information of the measurement result reporting of the neighbor candidate cell to the terminal equipment, the event triggered information being carried by configuration information of an MAC layer;
403: the network device of the serving cell transmits reporting configuration information to the terminal equipment;
404: the network device of the serving cell and/or a network device of a configured neighbor candidate cell transmit(s) associated reference signals;
405: the terminal equipment measures a received reference signal (L1-SNR or L1-RSRP);
406: the terminal equipment performs event evaluation or performs event evaluation and resource evaluation according to a measurement result;
407: the terminal equipment transmits a measurement report to the network device of the serving cell according to an evaluation result;
408: the network device of the serving cell selects a target cell for switch according to the measurement report;
409: the network device of the serving cell transmits a cell switch command of layer 1 or layer 2 to the terminal equipment; and
410: the terminal equipment switches to the target cell according to the switch command.

As shown in FIG. 5, the method includes:
501: a network device of a serving cell transmits reference signal measurement resource configuration information used for layer 1 measurement to the terminal equipment;
502: the network device of the serving cell transmits layer 1 reporting configuration information, including event triggered information of measurement result reporting of the neighbor candidate cell to the terminal equipment;
503: the network device of the serving cell and/or a network device of a configured neighbor candidate cell transmit(s) associated reference signals;
504: the terminal equipment measures a received reference signal (L1-SNR or L1-RSRP);
505: the terminal equipment performs event evaluation or performs event evaluation and resource evaluation according to a measurement result;
506: the terminal equipment transmits a measurement report to the network device of the serving cell according to an evaluation result;
507: the network device of the serving cell selects a target cell for switch according to the measurement report;
508: the network device of the serving cell transmits a cell switch command of layer 1 or layer 2 to the terminal equipment; and
509: the terminal equipment switches to the target cell according to the switch command. Implementations of 401-410 and 501-509 are as described above, which shall not be repeated herein any further.

In addition, FIGS. 4 and 5 further include a step that is not shown: the network device of the serving cell transmits event parameter information to the terminal equipment, the event parameter information including: an event identifier, and at least one of a threshold, an offset and a hysteresis parameter corresponding to the event identifier.

It should be noted that FIGS. 4 and 5 only schematically illustrate the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what are contained in FIGS. 4 and 5.

### Embodiments of a Third Aspect

The embodiments of this disclosure provide an information transceiving apparatus. The apparatus may be, for example, a network device, or one or some components or assemblies configured in the network device. Contents in the embodiments identical to those in the embodiments of the second aspect shall not be described herein any further.

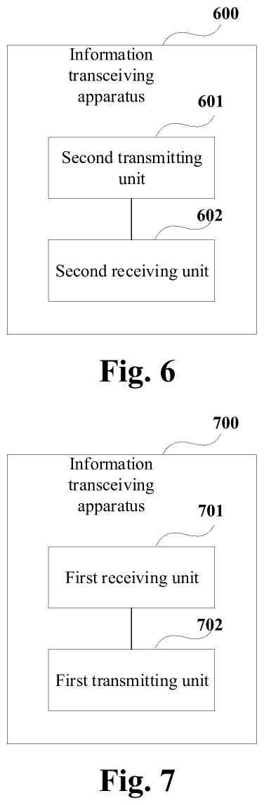

FIG. 6 is a schematic diagram of the information transceiving apparatus of the embodiments of this disclosure. As shown in FIG. 6, the information transceiving apparatus 600 includes a second transmitting unit 601 and a second receiving unit 602.

The second transmitting unit 601 is configured to transmit event triggered information of measurement result reporting of a neighbor candidate cell to a terminal equipment, the event triggered information being used to indicate the terminal equipment to trigger measurement result reporting of the neighbor candidate cell with an event as a condition, measurement of the neighbor candidate cell being used for layer 1/layer 2 triggered mobility.

The second receiving unit 602 is configured to receive a measurement report transmitted by the terminal equipment.

Reference may be made to the embodiments of the first aspect for implementations of the information and units, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 600 may further include other components or modules, and reference may be made to related techniques for particulars of these components or modules.

Furthermore, for the sake of simplicity, connection relationships between the components or modules or signal profiles thereof are only illustrated in FIG. 6. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fourth Aspect

The embodiments of this disclosure provide an information transceiving apparatus. The apparatus may be, for example, a terminal equipment, or one or some components or assemblies configured in the terminal equipment. Contents in the embodiments identical to those in the embodiments of the first aspect shall not be described herein any further.

FIG. 7 is a schematic diagram of the information transceiving apparatus of the embodiments of this disclosure. As shown in FIG. 7, the information transceiving apparatus 700 includes a first receiving unit 701 and a first transmitting unit 702.

The first receiving unit 701 is configured to receive event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility.

The first transmitting unit 702 is configured to transmit a measurement report to the network device according to the event triggered information.

Reference may be made to the embodiments of the first aspect for implementations of the information and units, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device 101 and/or a terminal equipment 102, wherein the network device 101 includes the information transceiving apparatus 600 described in the embodiments of the third aspect, and the terminal equipment 102 includes the information transceiving apparatus 700 described in the embodiments of the fourth aspect, which shall not be described herein any further.

The embodiments of this disclosure further provide a network device, which may be, for example, a base station. However, this disclosure is not limited thereto, and it may also be another network device.

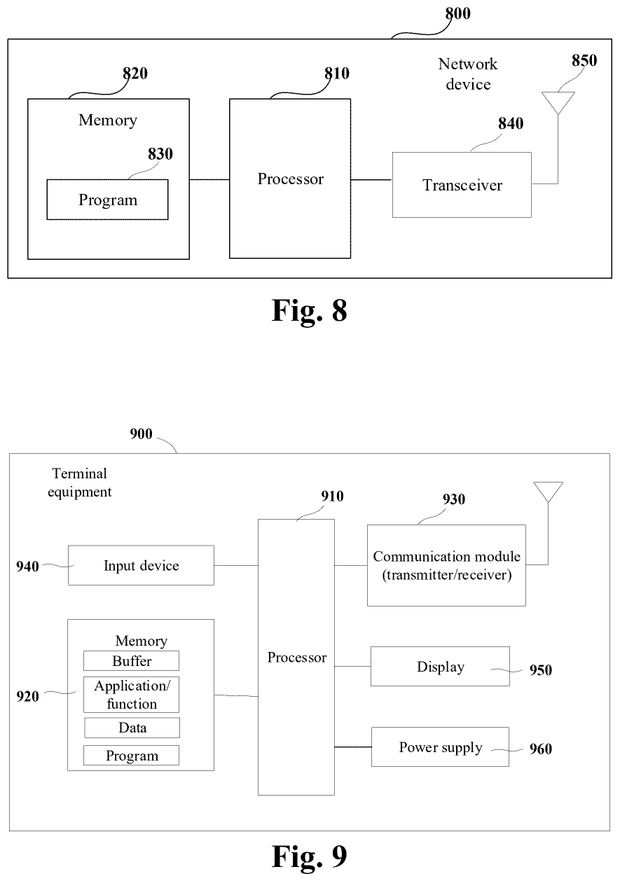

FIG. 8 is a schematic diagram of a structure of the network device of the embodiments of this disclosure. As shown in FIG. 8, the network device 800 may include a processor 810 (such as a central processing unit (CPU)) and a memory 820, the memory 820 being coupled to the processor 810. Wherein, the memory 820 may store various data, and furthermore, it may store a program 830 for information processing, and execute the program 830 under control of the processor 810.

For example, the processor 810 may be configured to execute a program to carry out the information transceiving method described in the embodiments of the second aspect.

Furthermore, as shown in FIG. 8, the network device 800 may include a transceiver 840, and an antenna 850, etc. Wherein, functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

The embodiments of this disclosure further provide a terminal equipment; however, this disclosure is not limited thereto, and it may also be another equipment.

FIG. 9 is a schematic diagram of the terminal equipment of the embodiments of this disclosure. As shown in FIG. 9, the terminal equipment 900 may include a processor 910 and a memory 920, the memory 920 storing data and a program and being coupled to the processor 910. It should be noted that this figure is illustrative only, and other types of structures may also be used, so as to supplement or replace this structure and achieve a telecommunications function or other functions.

For example, the processor 910 may be configured to execute a program to carry out the information transceiving method as described in the embodiments of the first aspect.

As shown in FIG. 9, the terminal equipment 900 may further include a communication module 930, an input device 940, a display 950, and a power supply 960; wherein functions of the above components are similar to those in the related art, which shall not be described herein any further. It should be noted that the terminal equipment 900 does not necessarily include all the parts shown in FIG. 9, and the above components are not necessary. Furthermore, the terminal equipment 900 may include parts not shown in FIG. 9, and the related art may be referred to.

Embodiments of this disclosure provide a computer readable program, which, when executed in a terminal equipment, will cause the terminal equipment to carry out the information transceiving method as described in the embodiments of the first aspect.

Embodiments of this disclosure provide a computer storage medium, including a computer readable program, which will cause a terminal equipment to carry out the information transceiving method as described in the embodiments of the first aspect.

Embodiments of this disclosure provide a computer readable program, which, when executed in a network device, will cause the network device to carry out the information transceiving method as described in the embodiments of the second aspect.

Embodiments of this disclosure provide a computer storage medium, including a computer readable program, which will cause a network device to carry out the information transceiving method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information transceiving method, applicable to a terminal equipment, characterized in that the method includes:
receiving, by the terminal equipment, event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility; and
transmitting a measurement report by the terminal equipment to the network device according to the event triggered information.

2. The method according to supplement 1, wherein the event triggered information is carried in configuration information of an MAC layer, or is carried in layer 1 reporting configuration information or an MAC CE.

3. The method according to supplement 2, wherein the configuration information of the MAC layer or the layer 1 reporting configuration information is carried by RRC signaling.

4. The method according to supplement 1, wherein the event triggered information includes an event identifier, or includes an event identifier and time-frequency resource information of the measurement result reporting of the neighbor candidate cell.

5. The method according to supplement 1, wherein the method further includes:
receiving, by the terminal equipment, event parameter information transmitted by the network device, the event parameter information including an event identifier, and at least one of a threshold, an offset and a hysteresis parameter corresponding to the event identifier.

6. The method according to supplement 1, wherein the method further includes:
measuring reference signal quality of the neighbor candidate cell to obtain a measurement result of the neighbor candidate cell;
and when the measurement result of the neighbor candidate cell satisfies an event entering condition, the terminal equipment starts to include a measurement result of a corresponding neighbor candidate cell in the measurement report, until the measurement result of the neighbor candidate cell satisfies an event leaving condition; and when the measurement result of the neighbor candidate cell satisfies the event leaving condition, the terminal equipment starts to exclude a measurement result of a corresponding neighbor candidate cell in the measurement report, until the measurement result of the neighbor candidate cell satisfies the event entering condition.

7. The method according to supplement 6, wherein the event entering condition includes that:
a measurement result of the neighbor candidate cell is greater than a measurement result of a current serving cell; or,
a measurement result of the neighbor candidate cell minus a hysteresis parameter is greater than a measurement result of a current serving cell; or,
a measurement result of the neighbor candidate cell is greater than a measurement result of a current serving cell plus an offset; or,
a measurement result of the neighbor candidate cell minus a hysteresis parameter is greater than a measurement result of a current serving cell plus an offset; or,
a measurement result of the neighbor candidate cell is greater than a threshold; or,
a measurement result of the neighbor candidate cell minus a hysteresis parameter is greater than a threshold.

8. The method according to supplement 6, wherein the event leaving condition includes that:
a measurement result of the neighbor candidate cell is less than a measurement result of a current serving cell; or,
a measurement result of the neighbor candidate cell plus a hysteresis parameter is less than a measurement result of a current serving cell; or,
a measurement result of the neighbor candidate cell is less than a measurement result of a current serving cell plus an offset; or,
a measurement result of the neighbor candidate cell plus a hysteresis parameter is less than a measurement result of a current serving cell plus an offset; or,
the measurement result of the neighbor candidate cell is less than a threshold; or,
a measurement result of the neighbor candidate cell plus a hysteresis parameter is less than a threshold.

9. The method according to supplement 1, wherein the terminal equipment generates an uplink MAC PDU to carry the measurement report, and transmits the measurement report to the network device on an uplink resource.

10. The method according to supplement 9, wherein when the uplink resource is unable to support reporting of the measurement report, the method further includes:
transmitting a scheduling request signal by the terminal equipment to the network device for requesting allocation of uplink resources, and receiving, by the terminal equipment, resource information of allocated uplink resources transmitted by the network device.

11. The method according to supplement 1, wherein the measurement report is carried by UCI.

12. The method according to supplement 1, wherein the measurement report is carried by an MAC PDU and UCI.

13. The method according to supplement 6, wherein the method further includes:
measuring reference signal quality of a serving cell by the terminal equipment to obtain a measurement result of the serving cell, the measurement report including the measurement result of the serving cell.

14. The method according to supplement 6 or 13, wherein the measurement result includes L1-RSRP or an L1-SNR.

15. An information transceiving method, applicable to a network device, characterized in that the method includes:
transmitting event triggered information of measurement result reporting of a neighbor candidate cell by the network device to a terminal equipment, the event triggered information being used to indicate the terminal equipment to trigger measurement result reporting of the neighbor candidate cell with an event as a condition, measurement of the neighbor candidate cell being used for layer 1/layer 2 triggered mobility; and
receiving, by the network device, a measurement report transmitted by the terminal equipment.

16. The method according to supplement 15, wherein the event triggered information is carried in configuration information of an MAC layer, or is carried in layer 1 reporting configuration information or an MAC CE.

17. The method according to supplement 15, wherein the event triggered information includes an event identifier, or includes an event identifier and time-frequency resource information of the measurement result reporting of the neighbor candidate cell.

18. The method according to supplement 15, wherein the method further includes:
transmitting event parameter information by the network device to the terminal equipment, the event parameter information including an event identifier, and at least one of a threshold, an offset and a hysteresis parameter corresponding to the event identifier.

19. The method according to supplement 15, wherein the measurement report is carried by an MAC PDU and/or UCI.

20. A network device, including a memory and a processor, the memory storing a computer program, and the processor being configured to execute the computer program to carry out the method as described in any one of supplements 15-19.

21. A terminal equipment, including a memory and a processor, the memory storing a computer program, and the processor being configured to execute the computer program to carry out the method as described in any one of supplements 1-14.

1. An information transceiving apparatus, applicable to a terminal equipment, the apparatus comprising:
a first receiver configured to receive event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility; and
a first transmitter configured to transmit a measurement report to the network device according to the event triggered information.

2. The apparatus according to claim 1, wherein the event triggered information is carried in configuration information of an MAC layer, or is carried in layer 1 reporting configuration information or an MAC CE.

3. The apparatus according to claim 2, wherein the configuration information of the MAC layer or the layer 1 reporting configuration information is carried by RRC signaling.

4. The apparatus according to claim 1, wherein the event triggered information comprises an event identifier, or comprises an event identifier and time-frequency resource information of the measurement result reporting of the neighbor candidate cell.

5. The apparatus according to claim 1, wherein the first receiver is further configured to receive event parameter information transmitted by the network device, the event parameter information comprising an event identifier, and at least one of a threshold, an offset and a hysteresis parameter corresponding to the event identifier.

6. The apparatus according to claim 1, the apparatus further comprising:
measurement processor circuitry configured to measure reference signal quality of the neighbor candidate cell to obtain a measurement result of the neighbor candidate cell; and
when the measurement result of the neighbor candidate cell satisfies an event entering condition, the terminal equipment starts to include a measurement result of a corresponding neighbor candidate cell in the measurement report, until the measurement result of the neighbor candidate cell satisfies an event leaving condition; and when the measurement result of the neighbor candidate cell satisfies the event leaving condition, the terminal equipment starts to exclude a measurement result of a corresponding neighbor candidate cell in the measurement report, until the measurement result of the neighbor candidate cell satisfies the event entering condition.

7. The apparatus according to claim 6, wherein the event entering condition comprises that:
a measurement result of the neighbor candidate cell is greater than a measurement result of a current serving cell; or,
a measurement result of the neighbor candidate cell minus a hysteresis parameter is greater than a measurement result of a current serving cell; or,
a measurement result of the neighbor candidate cell is greater than a measurement result of a current serving cell plus an offset; or,
a measurement result of the neighbor candidate cell minus a hysteresis parameter is greater than a measurement result of a current serving cell plus an offset; or,
a measurement result of the neighbor candidate cell is greater than a threshold; or,
a measurement result of the neighbor candidate cell minus a hysteresis parameter is greater than a threshold.

8. The apparatus according to claim 6, wherein the event leaving condition comprises that:
a measurement result of the neighbor candidate cell is less than a measurement result of a current serving cell; or,
a measurement result of the neighbor candidate cell plus a hysteresis parameter is less than a measurement result of a current serving cell; or,
a measurement result of the neighbor candidate cell is less than a measurement result of a current serving cell plus an offset; or,
a measurement result of the neighbor candidate cell plus a hysteresis parameter is less than a measurement result of a current serving cell plus an offset; or,
the measurement result of the neighbor candidate cell is less than a threshold; or,
a measurement result of the neighbor candidate cell plus a hysteresis parameter is less than a threshold.

9. The apparatus according to claim 1, wherein the first transmitter generates an uplink MAC PDU to carry the measurement report, and transmits the measurement report to the network device on an uplink resource.

10. The apparatus according to claim 9, wherein when the uplink resource is unable to support reporting of the measurement report, the first transmitter is further configured to transmit a scheduling request signal to the network device for requesting allocation of uplink resources, and the first receiver is further configured to receive resource information of allocated uplink resources transmitted by the network device.

11. The apparatus according to claim 1, wherein the first transmitter carries the measurement report by UCI.

12. The apparatus according to claim 1, wherein the first transmitter carries the measurement report by an MAC PDU and UCI.

13. The apparatus according to claim 6, wherein the measurement processor circuitry is further configured to measure reference signal quality of a serving cell to obtain a measurement result of the serving cell, the measurement report comprising the measurement result of the serving cell.

14. The apparatus according to claim 6, wherein the measurement result comprises L1-RSRP or an L1-SNR.

15. An information transceiving apparatus, applicable to a network device, the apparatus comprising:
a second transmitter configured to transmit event triggered information of measurement result reporting of a neighbor candidate cell to a terminal equipment, the event triggered information being used to indicate the terminal equipment to trigger measurement result reporting of the neighbor candidate cell with an event as a condition, measurement of the neighbor candidate cell being used for layer 1/layer 2 triggered mobility; and
a second receiver configured to receive a measurement report transmitted by the terminal equipment.

16. The apparatus according to claim 15, wherein the event triggered information is carried in configuration information of an MAC layer, or is carried in layer 1 reporting configuration information or an MAC CE.

17. The apparatus according to claim 15, wherein the event triggered information comprises an event identifier, or comprises an event identifier and time-frequency resource information of measurement result reporting of the neighbor candidate cell.

18. The apparatus according to claim 15, wherein the second transmitter is further configured to transmit event parameter information to the terminal equipment, the event parameter information comprising an event identifier, and at least one of a threshold, an offset and a hysteresis parameter corresponding to the event identifier.

19. The apparatus according to claim 15, wherein the measurement report is carried by an MAC PDU and/or UCI.

20. A communication system, comprising a terminal equipment and/or a network device,
wherein the terminal equipment comprises a first information transceiving apparatus, applicable to a terminal equipment, the first information transceiving apparatus comprising:
a first receiver configured to receive event triggered information of measurement result reporting of a neighbor candidate cell transmitted by a network device, the event triggered information being used to indicate the terminal equipment to trigger measurement result reporting of the neighbor candidate cell with an event as a condition, measurement of the neighbor candidate cell being used for layer 1/layer 2 triggered mobility; and
a first transmitter configured to transmit a measurement report to the network device according to the event triggered information, and
wherein the network device comprises a second information transceiving apparatus, applicable to a network device, the second information transceiving apparatus comprising:
a second transmitter configured to transmit event triggered information of measurement result reporting of a neighbor candidate cell to a terminal equipment, the event triggered information being used to indicate the terminal equipment to trigger measurement result reporting of the neighbor candidate cell with an event as a condition, measurement of the neighbor candidate cell being used for layer 1/layer 2 triggered mobility; and
a second receiver configured to receive a measurement report transmitted by the terminal equipment.
